(19) United States
(12) Patent Application Publication
(10) Pub. No.: US 2016/0133230 A1
(43) Pub. Date: May 12, 2016

(54) REAL-TIME SHARED AUGMENTED REALITY EXPERIENCE

(71) Applicant: BENT IMAGE LAB, LLC, PORTLAND, OR (US)

(72) Inventors: Oliver Clayton Daniels, Portland, OR (US); David Morris Daniels, Portland, OR (US); Raymond Victor Di Carlo, Portland, OR (US)

(73) Assignee: BENT IMAGE LAB, LLC, PORTLAND, OR (US)

(21) Appl. No.: 14/538,641

(22) Filed: Nov. 11, 2014

(51) Int. Cl. G09G 5/18; G09G 5/00; G06T 19/00

(52) U.S. Cl. CPC G09G 5/18; G06T 19/006; G09G 5/003; G09G 2370/022

(57) ABSTRACT

A system is provided for enabling a shared augmented reality experience. The system comprises zero, one or more on-site devices for generating augmented reality representations of a real-world location, and one or more off-site devices for generating virtual augmented reality representations of the real-world location. The augmented reality representations include data and or content incorporated into live views of a real-world location. The virtual augmented reality representations of the AR scene incorporate images and data from a real world location and include additional content used in an AR presentation. The on-site devices synchronize the content used to create the augmented reality experience with the off-site devices in real time such that the augmented reality representations and the virtual augmented reality representations are consistent with each other.

### RELATED APPLICATION

This application relates to U.S. Provisional Patent Application No. 62/078,287, entitled “Accurate Positioning of Augmented Reality Content”, which was filed on Nov. 11, 2014, the contents of which are expressly incorporated by reference herein.

### BACKGROUND OF THE INVENTION

1. Field of the Invention

The invention relates to positioning, locating, interacting and/or sharing augmented reality content and other location based information between people by the use of digital devices. More particularly, the invention concerns a framework for on-site devices and off-site devices to interact in a shared scene.

2. Description of the Related Art

Augmented Reality, (AR) is a live view of a real-world environment that includes supplemental computer generated elements such as sound, video, graphics, text or positioning data (e.g., global positioning system (GPS) data). For example, a user can use a mobile device or digital camera to view a live image of a real-world location, and the mobile device or digital camera can then be used to create an augmented reality experience by displaying the computer generated elements over the live image of the real world. The device presents the augmented reality to a viewer as if the computer generated content was a part of the real world.

A fiducial marker (e.g., an image with clearly defined edges, a quick response (QR) code, etc.), can be placed in a field of view of the capturing device. The fiducial marker serves as a reference point. Using the fiducial marker, the scale for rendering computer generated content can be determined by comparison calculations between the real world scale of the fiducial marker and its apparent size in the visual feed.

The augmented reality application can overlay any computer-generated information on top of the live view of the real-world environment. This augmented reality scene can be displayed on many devices, including but not limited to computers, phones, tablets, pads, headsets, HUDs, glasses, visors, and or helmets. For example, the augmented reality of a proximity-based application can include floating store or restaurant reviews on top of a live street view captured by a mobile device running the augmented reality application.

However, traditional augmented reality technologies generally present a first person view of the augmented reality experience to a person who is near the actual real-world location. Traditional augmented reality always takes place “on site” in a specific location, or when viewing specific objects or images, with computer-generated artwork or animation placed over the corresponding real-world live image using a variety of methods. This means only those who are actually viewing the augmented reality content in a real environment with can fully understand and enjoy the experience. The requirement of proximity to a real-world location or object significantly limits the number of people who can appreciate and experience an on-site augmented reality event at any given time.

### SUMMARY OF THE INVENTION

Here discloses a system for one or more people (also referred to as a user or users) to view, change and interact with one or more shared location based events simultaneously. Some of these people can be on-site and view the AR content placed in the location using the augmented live view of their mobile devices such as mobile phones or optical head-mounted displays. Other people can be off-site and view the AR content placed in a virtual simulation of reality, (i.e. off-site virtual augmented reality, or ovAR), via a computer, or other digital devices such as televisions, laptops, desktops, tablet computers and or VR glasses/Goggles. This virtually recreated augmented reality can be as simple as images of the real-world location, or as complicated as textured three-dimensional geometry.

The disclosed system provides location-based scenes containing images, artwork, games, programs, animations, scans, data, and/or videos that are created or provided by multiple digital devices and combines them with live views and virtual views of locations' environments separately or in parallel. For on-site users, the augmented reality includes the live view of the real-world environment captured by their devices. Off-site users, who are not at or near the physical location (or who choose to view the location virtually instead of physically), can still experience the AR event by viewing the scene, within a virtual simulated recreation of the environment or location. All participating users can interact with, change, and revise the shared AR event. For example, an off-site user can add images, artwork, games, programs, animations, scans, data and videos, to the common environment, which will then be propagated to all on-site and off-site users so that the additions can be experienced and altered once again. In this way, users from different physical locations can contribute to and participate in a shared social and/or community AR event that is set in any location.

Based on known geometry, images, and position data, the system can create an off-site virtual augmented reality (ovAR) environment for the off-site users. Through the ovAR environment, the off-site users can actively share AR content, games, art, images, animations, programs, events, object creation or AR experiences with other off-site or on-site users who are participating in the same AR event.

The off-site virtual augmented reality (ovAR) environment possesses a close resemblance to the topography, terrain, AR content and overall environment of the augmented reality events that the on-site users experience. The off-site digital device creates the ovAR off-site experience based on accurate or near-accurate geometry scans, textures, and images as well as the GPS locations of terrain features, objects, and buildings present at the real-world location.

An on-site user of the system can participate, change, play, enhance, edit, communicate and interact with an off-site user. The users all over the world can participate together by playing, editing, sharing, learning, creating art, and collaborating as part of AR events in AR games and programs.

A user can interact with the augmented reality event using a digital device and consequently change the AR event. Such a change can include, e.g., creating, editing, or deleting a piece of AR content. The AR event's software running on the user's digital device identifies and registers that an interaction has occurred; then the digital device sends the interaction information to some receiving host, such as a central server or similar data storage and processing hub, which then relays that information over the internet or a similar communication pipeline (such as a mesh network) to the digital devices of the other users who are participating in the AR event. The AR software running on the digital devices of the participating users receives the information and updates the AR event presented on the devices according to the specifics of the interaction. Thus, all users can see the change when viewing the AR event on a digital device, and those participating in the ongoing AR event can see the changes in real time or asynchronously on their digital devices.

Furthermore, users can place and control graphical representations created by or of themselves (also referred to as avatars) in a scene of an AR event. Avatars are AR objects and can be positioned anywhere, including at the point from which the user views the scene of the AR event (also referred to as point-of-view or PoV). On-site or off-site users can see and interact with avatars of other users. For example, a user can control their avatar's facial expression or body positioning by changing their facial expression or body position and having this change captured by one of many techniques, including computer vision or a structured light sensor.

The augmented reality can be used to blend human artistic expression with reality itself. It will blur the line between what is real and what is imagined. The technology further extends people's ability to interact with their environment and with other people, as anyone can share any AR experience with anyone else, anywhere.

With the disclosed system such an augmented reality event is no longer only a site-specific phenomenon. Off-site users can also experience a virtual version of the augmented reality and the site in which it is meant to exist. The users can provide inputs and scripts to alter the digital content, data, and avatars, as well as the interactions between these components, altering both the off-site and the on-site experience of the AR event. Functions and additional data can be added to AR events “on the fly”. A user can digitally experience a location from anywhere in the world regardless of its physical distance.

Such a system has the ability to project the actions and inputs of off-site participants into games and programs and the events, learning experiences, and tutorials inside them, as well as medical and industrial AR applications, i.e. telepresence. With telepresence, the off-site users can play, use programs, collaborate, learn, and interact with on-site users in the augmented reality world. This interaction involves inputs from both on-site and off-site digital devices, which allows the off-site and on-site users to be visualized together and interact with each other in an augmented reality scene. For example, by making inputs on an off-site device, a user can project an AR avatar representing themselves to a location and control its actions there.

### BRIEF DESCRIPTION OF THE DRAWINGS

FIG. 1 is a block diagram of the components and interconnections of an augmented reality (AR) sharing system, according to an embodiment of the invention.

FIG. 2A is a flow diagram showing an example mechanism for exchanging AR information, according to an embodiment of the invention.

FIG. 2B is a flow diagram showing a mechanism for exchanging and synchronizing augmented reality information among multiple devices in an ecosystem, according to an embodiment of the invention.

FIG. 2C is a block diagram showing on-site and off-site devices visualizing a shared augmented reality event from different points of views, according to an embodiment of the invention.

FIG. 2D is a flow diagram showing a mechanism for exchanging information between an off-site virtual augmented reality (ovAR) application and a server, according to an embodiment of the invention.

FIG. 2E is a flow diagram showing a mechanism for propagating interactions between on-site and off-site devices, according to an embodiment of the invention.

FIGS. 3A and 3B are illustrative diagrams showing how a mobile position orientation point (MPOP) allows for the creation and viewing of augmented reality that has a moving location, according to embodiments of the invention.

FIGS. 3C and 3D are illustrative diagrams showing how AR content can be visualized by an on-site device in real time, according to embodiments of the invention.

FIG. 4A is a flow diagram showing a mechanism for creating an off-site virtual augmented reality (ovAR) representation for an off-site device, according to an embodiment of the invention.

FIG. 4B is a flow diagram showing a process of deciding the level of geometry simulation for an off-site virtual augmented reality (ovAR) scene, according to an embodiment of the invention.

FIG. 5 is a block schematic diagram of a digital data processing apparatus, according to an embodiment of the invention.

FIGS. 6A and 6B are illustrative diagrams showing an AR Vector being viewed both on-site and off-site simultaneously.

### DETAILED DESCRIPTION

The nature, objectives, and advantages of the invention will become more apparent to those skilled in the art after considering the following detailed description in connection with the accompanying drawings.

### Environment of Augmented Reality Sharing System

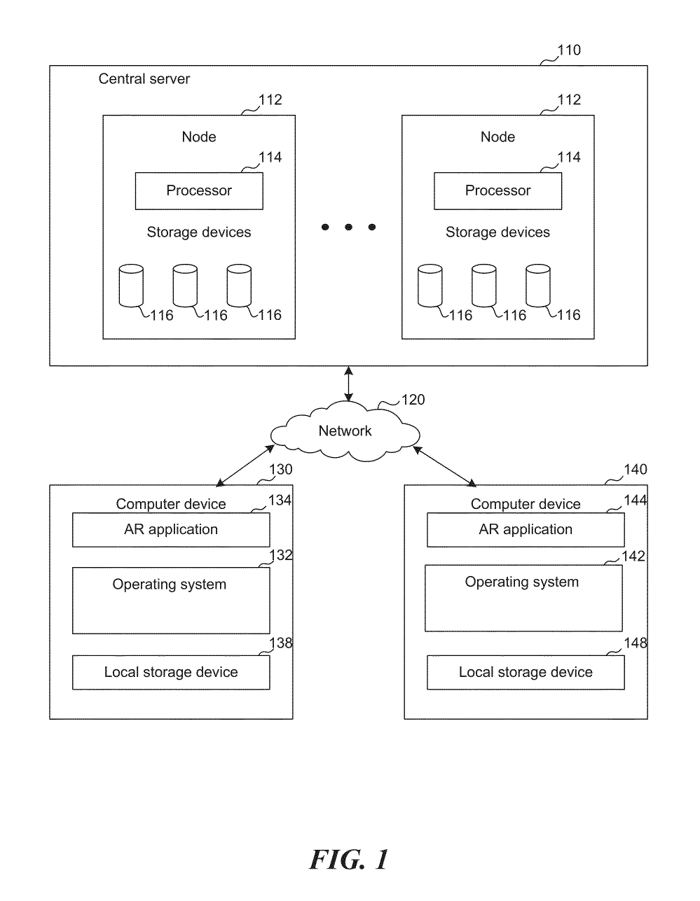

FIG. 1 is a block diagram of the components and interconnections of an augmented reality sharing system, according to an embodiment of the invention. The central server 110 is responsible for storing and transferring the information for creating the augmented reality. The central server 110 is configured to communicate with multiple computer devices. In one embodiment, the central server 110 can be a server cluster having computer nodes interconnected with each other by a network. The central server 110 can contain nodes 112. Each of the nodes 112 contains one or more processors 114 and storage devices 116. The storage devices 116 can include optical disk storage, RAM, ROM, EEPROM, flash memory, phase change memory, magnetic cassettes, magnetic tapes, magnetic disk storage or any other computer storage medium which can be used to store the desired information.

The computer devices 130 and 140 can each communicate with the central server 110 via network 120. The network 120 can be, e.g., the Internet. For example, an on-site user in proximity to a particular physical location can carry the computer device 130; while an off-site user who is not proximate to the location can carry the computer device 140. Although FIG. 1 illustrates two computer devices 130 and 140, a person having ordinary skill in the art will readily understand that the technology disclosed herein can be applied to a single computer device or more than two computer devices connected to the central server 110. For example, there can be multiple on-site users and multiple off-site users who participate in one or more AR events by using one or more computing devices.

The computer device 130 includes an operating system 132 to manage the hardware resources of the computer device 130 and provides services for running the AR application 134. The AR application 134, stored in the computer device 130, requires the operating system 132 to properly run on the device 130. The computer device 130 includes at least one local storage device 138 to store the computer applications and user data. The computer device 130 or 140 can be a desktop computer, a laptop computer, a tablet computer, an automobile computer, a game console, a smart phone, a personal digital assistant, smart TV, set top box, DVR, Blu-Ray, residential gateway, over-the-top Internet video streamer, or other computer devices capable of running computer applications, as contemplated by a person having ordinary skill in the art.

### Augmented Reality Sharing Ecosystem Including On-Site and Off-Site Devices

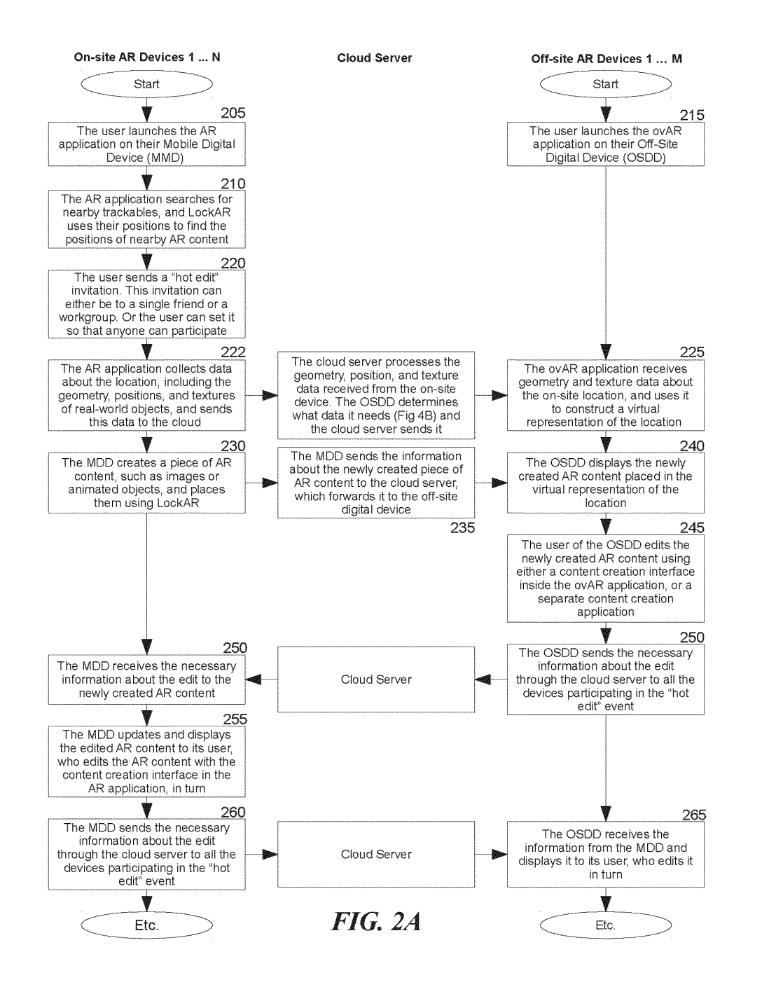

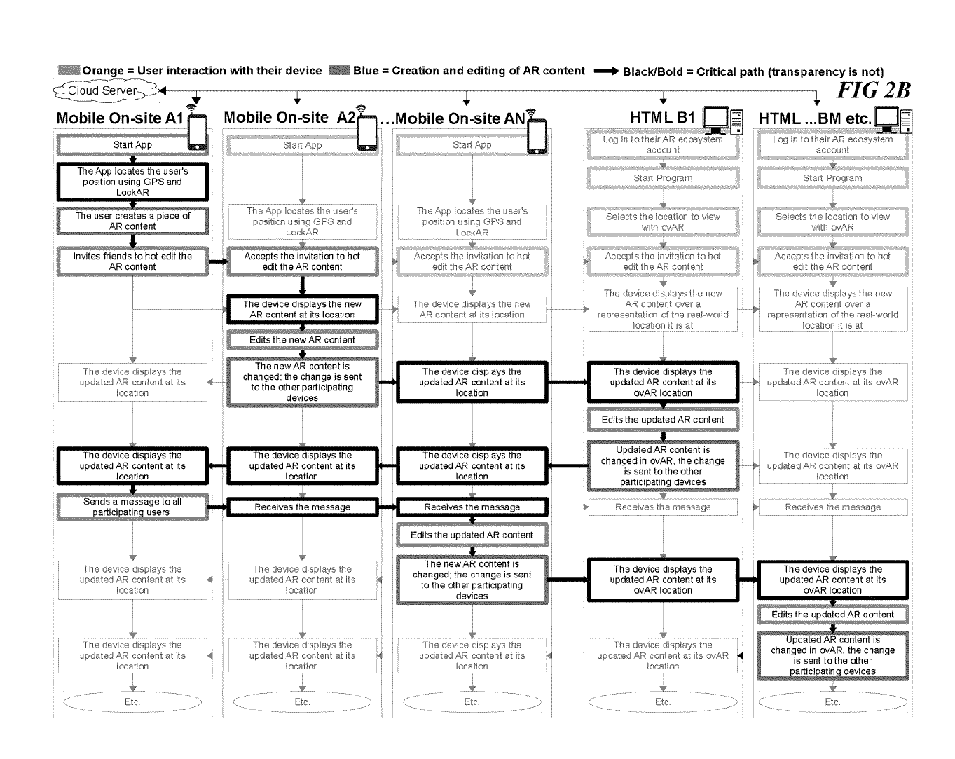

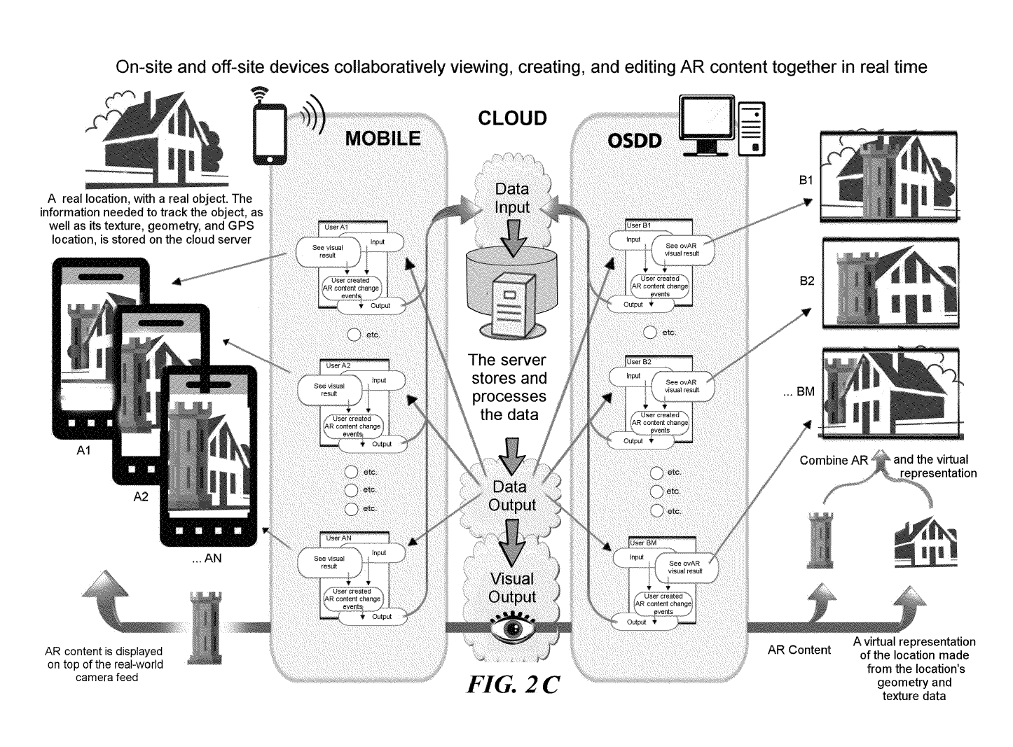

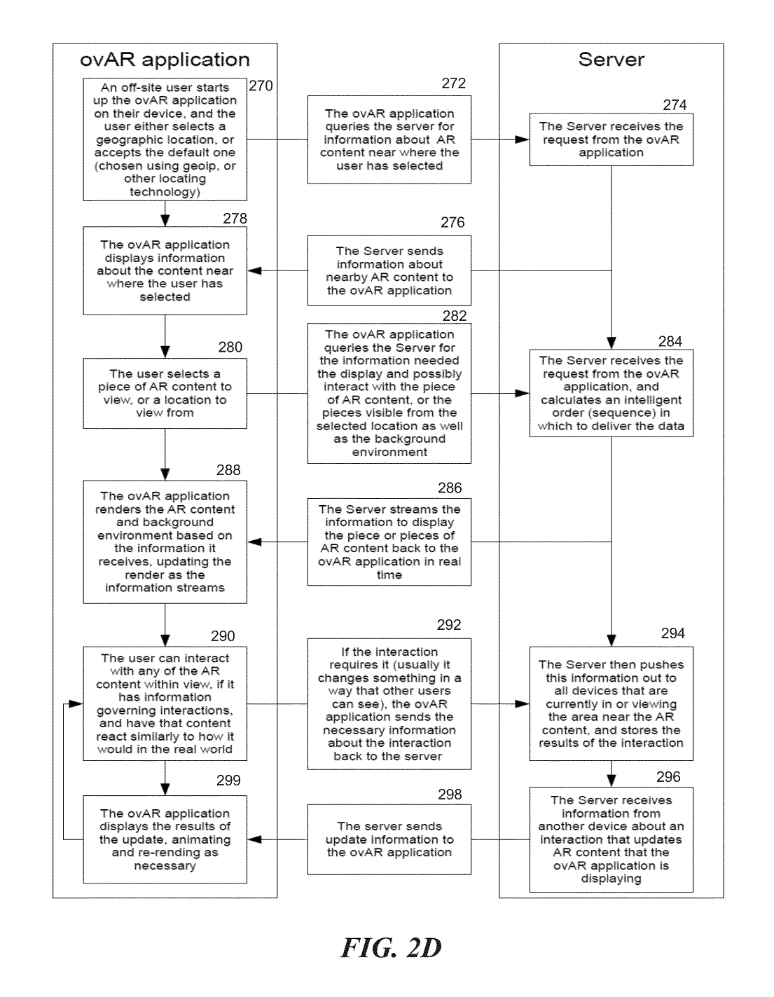

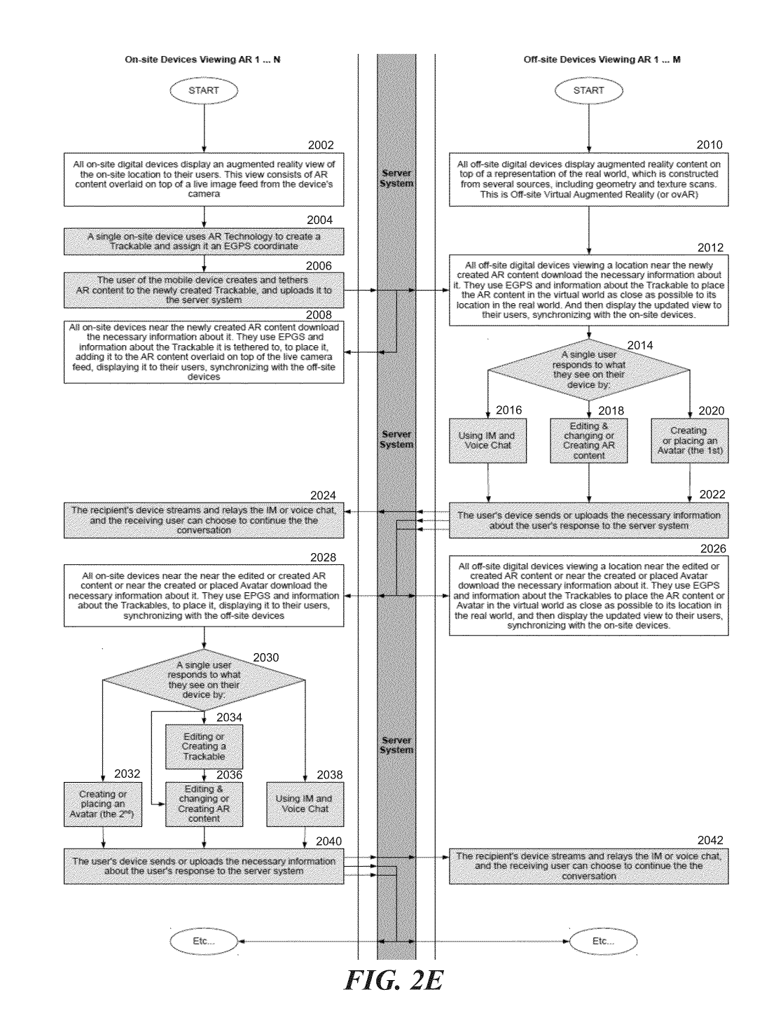

The computing devices of on-site and off-site AR users can exchange information through a central server so that the on-site and off-site AR users experience the same AR event at approximately the same time. FIG. 2A is a flow diagram showing an example mechanism for the purpose of facilitating multiple users to simultaneously edit AR content and objects (also referred to as hot-editing), according to an embodiment of the invention. In the embodiment illustrated in FIG. 2A, an on-site user uses a mobile digital device (MDD); while an off-site user uses an off-site digital device (OSDD). The MDD and OSDD can be various computing devices as disclosed in previous paragraphs.

At block 205, the mobile digital device (MDD) opens up an AR application that links to a larger AR ecosystem, allowing the user to experience shared AR events with any other user connected to the ecosystem. In some alternative embodiments, an on-site user can use an on-site computer instead of a MDD. At block 210, the MDD acquires real-world positioning data using techniques including, but not limited to: GPS, visual imaging, geometric calculations, gyroscopic or motion tracking, point clouds, and other data about a physical location, and prepares an on-site canvass for creating the AR event. The fusion of all these techniques is collectively called LockAR. Each piece of LockAR data (Trackable) is tied to a GPS position and has associated meta-data, such as estimated error and weighted measured distances to other features. The LockAR data set can include Trackables such as textured markers, fiducial markers, geometry scans of terrain and objects, SLAM maps, electromagnetic maps, localized compass data, Landmark recognition and triangulation data as well as the position of these Trackables relative to other LockAR Trackables. The user carrying the MDD is in proximity to the physical location.

At block 215, the OSDD of an off-site user opens up another application that links to the same AR ecosystem as the on-site user. The application can be a web app running within the browser. It can also be, but is not limited to, a native, Java, or Flash application. In some alternative embodiments, an off-site user can use a mobile computing device instead of an OSDD.

At block 220, the MDD sends editing invitations to the AR applications of off-site users (e.g., friends) running on their OSDDs via the cloud server (or a central server). The off-site users can be invited singularly or en masse by inviting an entire workgroup or friend list. At block 222, the MDD sends on-site environmental information and the associated GPS coordinates to the server, which then propagates it to the OSDDs.

At block 225, the OSDD creates a simulated, virtual background based on the site specific data and GPS coordinates it received. Within this off-site virtual augmented reality (ovAR) scene, the user sees a world that is fabricated by the computer based on the on-site data. The ovAR scene is different from the augmented reality scene, but can closely resemble it. The ovAR is a virtual representation of the location that includes many of the same AR objects as the on-site augmented reality experience; for example, the off-site user can see the same fiducial markers as the on-site user as part of the ovAR, as well as the AR objects tethered to those markers.

At block 230, the MDD creates AR data or content, pinned to a specific location in the augmented reality world, based on the user instructions it received through the user interface of the AR application. The specific location of the AR data or content is identified by environmental information within the LockAR data set. At block 235, the OSDD receives the AR content and the LockAR data specifying its location. At block 240, the AR application of the OSDD places the received AR content within the simulated, virtual background. Thus, the off-site user can also see an off-site virtual augmented reality (ovAR) which substantially resembles the augmented reality seen by an on-site user.

At block 245, the OSDD alters the AR content based on the user instructions received from the user interface of the AR application running on the OSDD. The user interface can include elements enabling the user to specify the changes made to the data and to the 2D and 3D content. At block 250, the OSDD sends the altered AR content to the other users participating in the AR event (also referred to as a hot-edit event).

After receiving the altered AR data or content from the OSDD via the cloud server or some other system, (block 250), the MDD updates the original piece of AR data or content to the altered version and then incorporates it into the AR scene using the LockAR data to place it in the virtual location that corresponds to its on-site location (block 255).

At blocks 255 and 260, the MDD can, in turn, further alter the AR content and send the alterations back to the other participants in the AR event (e.g., hot-edit event). At block 265, again the OSDD receives, visualizes, alters and sends back the AR content creating a “change” event based on the interactions of the user. The process can continue, and the devices participating in the AR event can continuously change the augmented reality content and synchronize it with the cloud server (or other system).

The AR event can be shared by multiple on-site and off-site users through AR and ovAR respectively. These users can be invited en masse, as a work group, individually from among their social network friends, or chose to join the AR event individually. When multiple on-site and off-site users participate in the AR event, multiple “change” events based on the interactions of the users can be processed simultaneously. The AR event can allow various types of user interaction, such as editing AR artwork or audio, changing AR images, doing AR functions within a game, viewing and interacting with live AR projections of off-site locations and people, choosing which layers to view in a multi-layered AR image, and choosing which subset of AR channels/layers to view. Channels refer to sets of AR content that have been created or curated by a developer, user, or administer. An AR channel event can have any AR content, including but not limited to images, animations, live action footage, sounds, or haptic feedback (e.g., vibrations or forces applied to simulate a sense of touch).

The system for sharing an argument reality event can include multiple on-site devices and multiple off-site devices. FIG. 2B is a flow diagram showing a mechanism for exchanging and synchronizing augmented reality information among devices in a system. This includes N on-site mobile devices A1 to N1, and M off-site devices A2 to M2. The on-site mobile devices A1 to N1 and off-site devices A2 to M2 synchronize their AR content with each-other.

As FIG. 2B illustrates, all the involved devices must first start an AR application and then connect to the central system, which is a cloud server in this manifestation of the invention. The on-site devices gather positional and environmental data to create new LockAR data or improve the existing LockAR data about the scene. The environmental data can include information collected by techniques such as simultaneous localization and mapping (SLAM), structured light, photogrammetry, geometric mapping, etc. The off-site devices create an off-site virtual augmented reality (ovAR) version of the location which uses a 3D-map made from data stored in the server's databases, which stores the relevant data generated by the on-site devices.

Then the user of on-site device A1 invites friends to participate in the event (called a hot-edit event). Users of other devices accept the hot-edit event invitations. The on-site device A1 sends AR content to the other devices via the cloud server. On-site devices A1 to AN composite the AR content with live views of the location to create the augmented reality scene for their users. Off-site devices B1 to BM composite the AR content with the simulated ovAR scene.

Any user of an on-site or off-site device participating in the hot-edit event can create new AR content or revise the existing AR content. The changes are distributed to all participating devices, which then update their presentations of the augmented reality and the off-site virtual augmented reality, so that all devices present variations of the same scene.

Although FIG. 2B illustrates the use of a cloud server for relaying all of the AR event information, a central server, a mesh network, or a peer-to-peer network can serve the same functionality, as a person having ordinary skill in the field can appreciate. In a mesh network, each device on the network can be a mesh node to relay data. All these devices (e.g., nodes) cooperate in distributing data in the mesh network, without needing a central hub to gather and direct the flow of data. A peer-to-peer network is a distributed network of applications that partitions the work load of data communications among the peer device nodes.

The off-site virtual augmented reality (ovAR) application can use data from multiple on-site devices to create a more accurate virtual augmented reality scene. FIG. 2C is a block diagram showing on-site and off-site devices visualizing a shared augmented reality event from different point of views.

The on-site devices A1 to AN create augmented reality versions of the real-world location based on the live views of the location they capture. The point of view of the real-world location can be different for the on-site devices A1 to AN, as the physical locations of the on-site devices A1 to AN are different.

The off-site devices B1 to BM have an off-site virtual augmented reality application which places and simulates a virtual representation of the real-world scene. The point of view from which they see the simulated real-world scene can be different for each of the off-site devices B1 to BM, as the users off-site devices B1 to BM can choose their own point of view (e.g., the location of the virtual device or avatar) in the ovAR scene. For example, the user of an off-site device can choose to view the scene from the point of view of any user's avatar. Alternatively, the user of the off-site device can choose a third-person point of view of another user's avatar, such that part or all of the avatar is visible on the screen of the off-site device and any movement of the avatar moves the camera the same amount. The user of the off-site device can choose any other point of view they wish, e.g., based on an object in the augmented reality scene, or an arbitrary point in space.

FIG. 2D is a flow diagram showing a mechanism for exchanging information between an off-site virtual augmented reality (ovAR) application and a server, according to an embodiment of the invention. At block 270, an off-site user starts up an ovAR application on a device. The user can either select a geographic location, or stay at the default geographic location chosen for them. If the user selects a specific geographic location, the ovAR application shows the selected geographic location at the selected level of zoom. Otherwise, the ovAR displays the default geographic location, centered on the system's estimate of the user's position (using technologies such as geoip). At block 272, the ovAR application queries the server for information about AR content near where the user has selected. At block 274, the server receives the request from the ovAR application.

Accordingly at block 276, the server sends information about nearby AR content to the ovAR application running on the user's device. At block 278, the ovAR application displays information about the content near where the user has selected on an output component (e.g., a display screen of the user's device). This displaying of information can take the form, for example, of selectable dots on a map which provide additional information, or selectable thumbnail images of the content on a map.

At block 280, the user selects a piece of AR content to view, or a location to view AR content from. At block 282, the ovAR application queries the server for the information needed for display and possibly for interaction with the piece of AR content, or the pieces of AR content visible from the selected location, as well as the background environment. At block 284, the server receives the request from the ovAR application and calculates an intelligent order in which to deliver the data.

At block 286, the server streams the information needed to display the piece or pieces of AR content back to the ovAR application in real time (or asynchronously). At block 288, the ovAR application renders the AR content and background environment based on the information it receives, and updating the rendering as the ovAR application continues to receive information.

At block 290, the user interacts with any of the AR content within the view. If the ovAR application has information governing interactions with that piece of AR content, the ovAR application processes and renders the interaction in a way similar to how the interaction would be processed and displayed by a device in the real world. At block 292, if the interaction changes something in a way that other users can see or changes something in a way that will persist, the ovAR application sends the necessary information about the interaction back to the server. At block 294, the server pushes the received information to all devices that are currently in or viewing the area near the AR content and stores the results of the interaction.

At block 296, the server receives information from another device about an interaction that updates AR content that the ovAR application is displaying. At block 298, the server sends the update information to the ovAR application. At block 299, the ovAR application updates the scene based on the received information, and displays the updated scene. The user can continue to interact with the AR content (block 290) and the server can continue to push the information about the interaction to the other devices (block 294).

FIG. 2E is a flow diagram showing a mechanism for propagating interactions between on-site and off-site devices, according to an embodiment of the invention. The flow diagram represents a set of use-cases where users are propagating interactions. The interactions can start with the on-site devices, then the interactions occur on the off-site devices, and the pattern of propagating interactions repeats cyclically. Alternatively, the interactions can start with the off-site devices, and then the interactions occur on the on-site devices, etc. Each individual interaction can occur on-site or off-site, regardless of where the previous or future interactions occur. The gray fill of the FIG. 2E denotes a block that applies to a single device, rather than multiple devices (e.g., all on-site devices or all off-site devices).

At block 2002, all on-site digital devices display an augmented reality view of the on-site location to the users of the respective on-site devices. The augmented reality view of the on-site devices includes AR content overlaid on top of a live image feed from the device's camera (or other image/video capturing component). At block 2004, one of the on-site device users use AR technology to create a trackable object and assign the trackable object a location coordinate (e.g., GPS coordinate). At block 2006, the user of the on-site device creates and tethers AR content to the newly created trackable object and uploads the AR content and the trackable object data to the server system.

At block 2008, all on-site devices near the newly created AR content download the necessary information about the AR content and its corresponding trackable object from the server system. The on-site devices use the location coordinates (e.g., GPS) of the trackable object to add the AR content to the AR content layer which is overlaid on top of the live camera feed. The on-site devices display the AR content to their respective users and synchronize information with the off-site devices.

On the other hand at block 2010, all off-site digital devices display augmented reality content on top of a representation of the real world, which is constructed from several sources, including geometry and texture scans. The augmented reality displayed by the off-site devices is called off-site virtual augmented reality (ovAR). At block 2012, the off-site devices that are viewing a location near the newly created AR content download the necessary information about the AR content and the corresponding trackable object. The off-site devices use the location coordinates (e.g., GPS) of the trackable object to place the AR content in the virtual world as close as possible to its location in the real world. The off-site devices then display the updated view to their respective users and synchronize information with the on-site devices.

At block 2014, a single user responds to what they see on their device in various ways. For example, the user can respond to what they see by using instant messaging (IM) or voice chat (block 2016). The user can also respond to what they see by editing, changing, or creating AR content (block 2018). Finally, the user can also respond to what they see by creating or placing an avatar (block 2020).

At block 2022, the user's device sends or uploads the necessary information about the user's response to the server system. If the user responds by IM or voice chat, at block 2024, the receiving user's device streams and relays the IM or voice chat. The receiving user (recipient) can choose to continue the conversation.

At block 2026, if the user responds by editing or creating AR content or an avatar, all off-site digital devices that are viewing a location near the edited or created AR content or near the created or placed avatar download the necessary information about the AR content or avatar. The off-site devices use the location coordinates (e.g., GPS) of the trackable object to place the AR content or avatar in the virtual world as close as possible to its location in the real world. The off-site devices display the updated view to their respective users and synchronize information with the on-site devices.

At block 2028, all the on-site devices near the edited or created AR content or near the created or placed avatar download the necessary information about the AR content or avatar. The on-site devices use the location coordinates (e.g., GPS) of the trackable object to place the AR content or avatar. The on-site devices display the AR content or avatar to their respective users and synchronize information with the off-site devices.

At block 2030, a single on-site user responds to what they see on their device in various ways. For example, the user can respond to what they see by using instant messaging (IM) or voice chat (block 2038). The user can also respond to what they see by creating or placing another avatar (block 2032). The user can also respond to what they see by editing or creating a trackable object and assigning the trackable object a location coordinate (block 2034). The user can further edit, change or create AR content (2036).

At block 2040, the user's on-site device sends or uploads the necessary information about the user's response to the server system. At block 2042, a receiving user's device streams and relays the IM or voice chat. The receiving user can choose to continue the conversation. The propagating interactions between on-site and off-site devices can continue.

### Augmented Reality Position and Geometry Data (“LockAR”)

The LockAR system can use quantitative analysis and other methods to improve the users AR experience. These methods could include but are not limited to; analyzing and or linking to data regarding the geometry of the objects and terrain, defining the position of AR content in relation to one or more trackable objects a.k.a. tethering, and coordinating/filtering/analyzing data regarding position, distance, orientation between trackable objects, as well as between trackable objects and on-site devices. This data set is referred to herein as environmental data. In order to accurately display computer-generated objects/content within a view of a real-world scene, know here as an augmented reality event, the AR system needs to acquire this environment data as well as the on-site user positions. LockAR's ability to integrate this environmental data for a particular real-world location with the quantitative analysis of other systems can be used to improve the positioning accuracy of new and existing AR technologies. Each environmental data set of an augmented reality event can be associated with a particular real-world location or scene in many ways, which includes but is not be limited to application specific location data, geofencing data and geofencing events.

The application of the AR sharing system can use GPS and other triangulation technologies to generally identify the location of the user. The AR sharing system then loads the LockAR data corresponding to the real-world location where the user is situated. Based on the position and geometry data of the real-world location, the AR sharing system can determine the relative locations of AR content in the augmented reality scene. For example, the system can decide the relative distance between an avatar (an AR content object) and a fiducial marker, (part of the LockAR data). Another example is to have multiple fiducial markers with an ability to cross reference positions, directions and angles to each other, so the system can refine and improve the quality and relative position of location data in relationship to each other whenever a viewer uses an enabled digital device to perceive content on location.

The augmented reality position and geometry data (LockAR) can include information in addition to GPS and other beacon and signal outpost methods of triangulation. These technologies can be imprecise in some situations with inaccuracy up to hundreds of feet. The LockAR system can be used to improve on site location accuracy significantly.

For an AR system which uses only GPS, a user can create an AR content object in a single location based on the GPS coordinate, only to return later and find the object in a different location, as GPS signal accuracy and margin of error are not consistent. If several people were to try to make AR content objects at the same GPS location at different times, their content would be placed at different locations within the augmented reality world based on the inconsistency of the GPS data available to the AR application at the time of the event. This is especially troublesome if the users are trying to create a coherent AR world, where the desired effect is to have AR content or objects to interact with other AR or real world content or objects.

The environmental data from the scenes, and the ability to correlate nearby position data to improve accuracy provides a level of precision that is necessary for applications which enable multiple users to interact and edit AR content simultaneously or over time in a shared augmented reality space. LockAR data can also be used to improve the off-site VR experience (i.e., the off-site virtual augmented reality “ovAR”), by increasing the precision of the representation of the real world scene as it is used for the creation and placement of the AR content in ovAR relative to the use/placement in the actual real world scene by enhancing the translation/positional accuracy through LockAR when the content is then reposted to a real world location. This can be a combination of general and ovAR specific data sets.

The LockAR environmental data for a scene can include and be derived from various types of information gathering techniques and or systems for additional precision. For example, using computer vision techniques, a 2D fiducial marker can be recognized as an image on a flat plane or defined surface in the real world. The system can identify the orientation and distance of the fiducial marker and can determine other positions or object shapes relative to the fiducial marker. Similarly, 3Dmarkers of non-flat objects can also be used to mark locations in the augmented reality scene. Combinations of these various fiducial marker technologies can be related to each other, to improve the quality of the data/positioning that each nearby AR technology imparts.

The LockAR data can include data collected by a simultaneous localization and mapping (SLAM) technique. The SLAM technique creates textured geometry of a physical location on the fly from a camera and/or structured light sensors. This data can be used to pinpoint the AR content's position relative to the geometry of the location, and also to create virtual geometry with the corresponding real world scene placement which can be viewed off-site to enhance the ovAR experience. Structured light sensors, e.g., IR or lasers, can be used to determine the distance and shapes of objects and to create 3D point-clouds or other 3D mapping data of the geometry present in the scene.

The LockAR data can also include accurate information regarding the location, movement and rotation of the user's device. This data can be acquired by techniques such as pedestrian dead reckoning (PDR) and/or sensor platforms.

The accurate position and geometry data of the real world and the user, creates a robust web of positioning data. Based on the LockAR data, the system knows the relative positions of each fiducial marker and each piece of SLAM or pre-mapped geometry. So, by tracking/locating any one of the objects in the real world location, the system can determine the positions of other objects in the location and the AR content can be tied to or located relative to actual real-world objects. The movement tracking and relative environmental mapping technologies can allow the system to determine, with a high degree of accuracy, the location of a user, even with no recognizable object in sight, as long as the system can recognizes a portion of the LockAR data set.

In addition to static real-world locations, the LockAR data can be used to place AR content at mobile locations as well. The mobile locations can include, e.g., ships, cars, trains, planes as well as people. A set of LockAR data associated with a moving location is called mobile LockAR. The position data in a mobile LockAR data set are relative to GPS coordinates of the mobile location (e.g. from a GPS enabled device at or on the mobile location which continuously updates the orientation of this type of location). The system intelligently interprets the GPS data of the mobile location, while making predictions of the movement of the mobile location.

In some embodiments, to optimize the data accuracy of mobile LockAR, the system can introduce a mobile position orientation point, (MPOP), which is the GPS coordinates of a mobile location over time interpreted intelligently to produce the best estimate of the location's actual position and orientation. This set of GPS coordinates describes a particular location, but an object, or collection of AR objects or LockAR data objects, may not be at the exact center of the mobile location it's linked to. The system calculates the actual GPS location of a linked object by offsetting its position from the mobile position orientation point, (MPOP), based on either hand-set values or algorithmic principles when the location of the object is known relative to the MPOP at its creation.

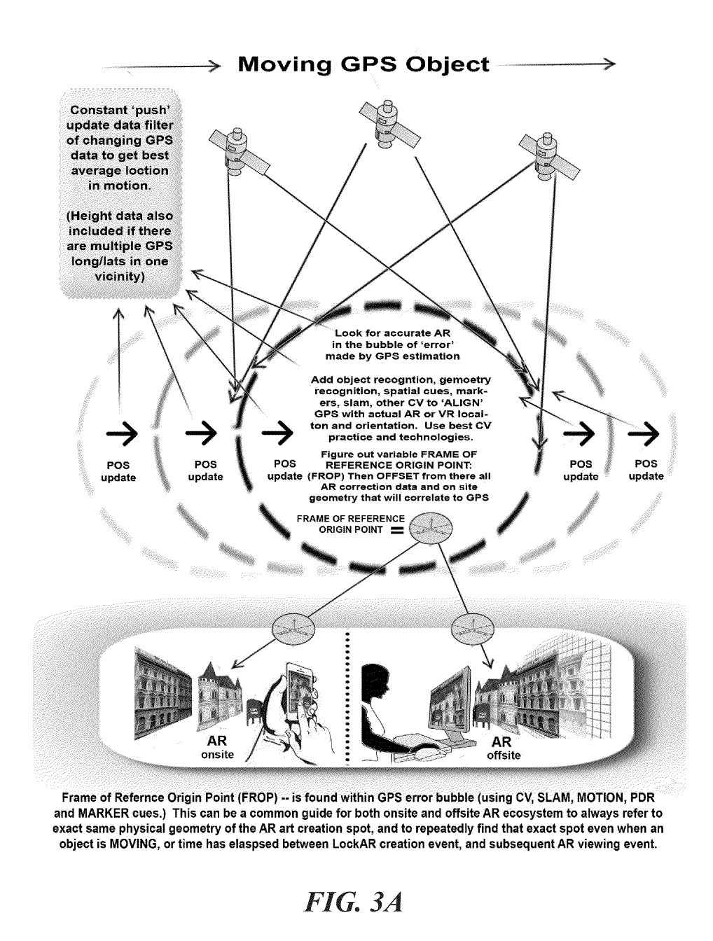

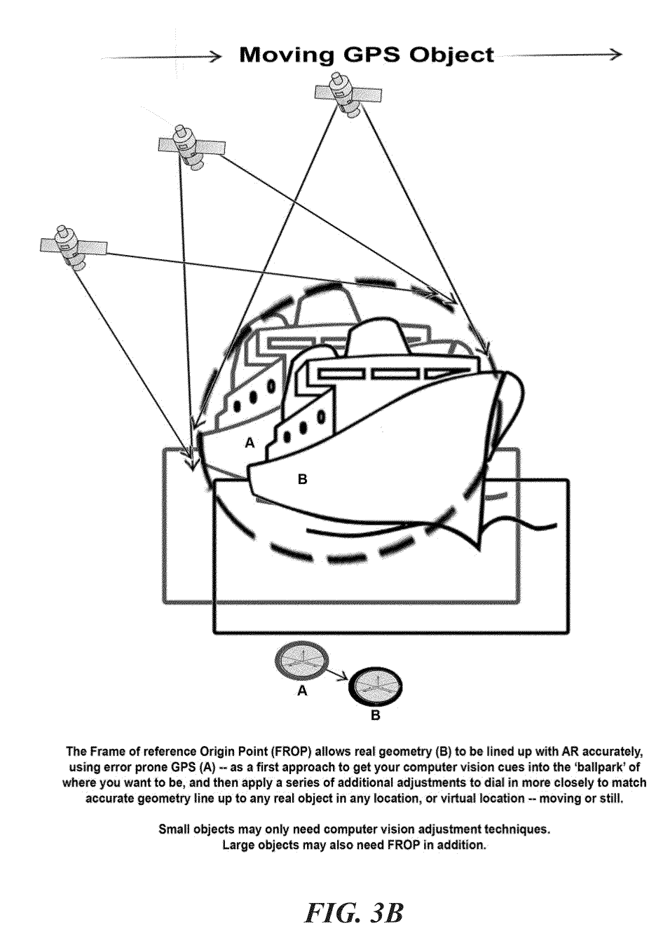

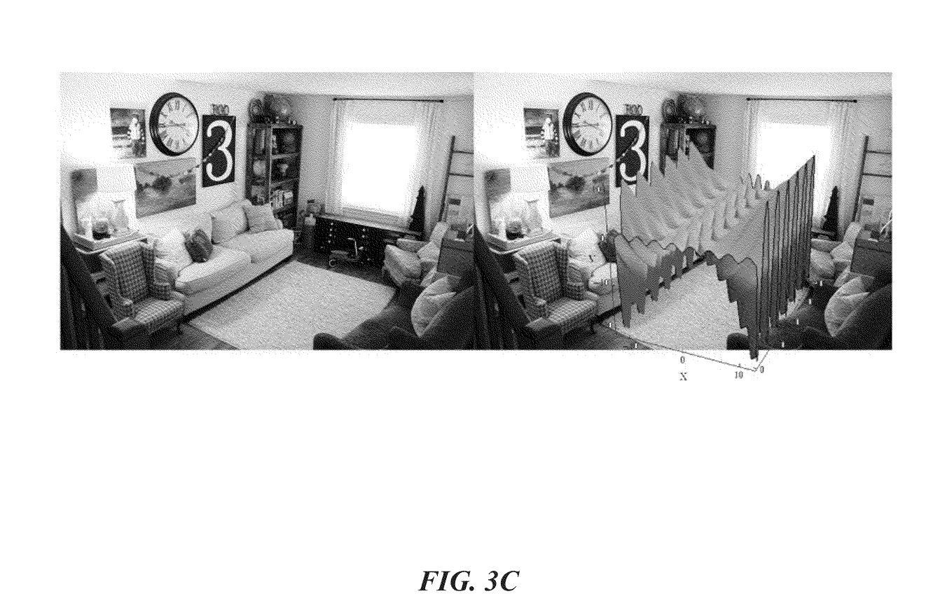

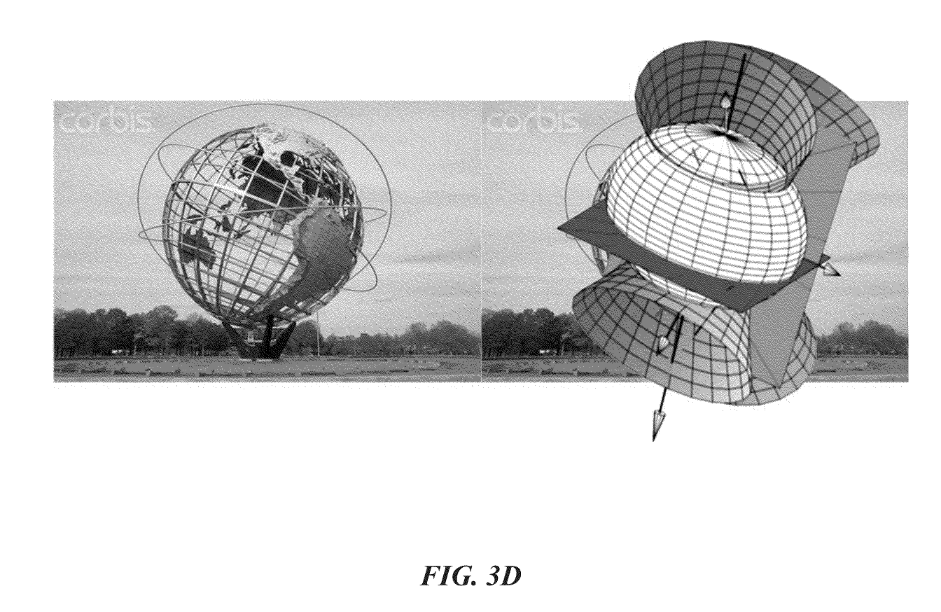

FIGS. 3A and 3B illustrate how a mobile position orientation point, (MPOP), allows for the creation and viewing of augmented reality that has a moving location. As FIG. 3A illustrates, the mobile position orientation point, (MPOP), can be used by on-site devices to know when to look for a Trackable and by off-site devices for roughly determining where to display mobile AR objects. As FIG. 3B illustrates, the mobile position orientation point, (MPOP), allows the augmented reality scene to be accurately lined up with the real geometry of the moving object. The system first finds the approximate location of the moving object based on its GPS coordinates, and then applies a series of additional adjustments to more accurately match the MPOP location and heading to the actual location and heading of the real-world object, allowing the augmented reality world to match an accurate geometric alignment with the real object or a multiple set of linked real objects.

In some embodiments, the system can also set up LockAR locations in a hierarchical manner. The position of a particular real-world location associated with a LockAR data set can be described in relation to another position of another particular real-world location associated with a second LockAR data set, rather than being described using GPS coordinates directly. Each of the real-world locations in the hierarchy has its own associated LockAR data set including, e.g., fiducial marker positions and object/terrain geometry.

The LockAR data set can have various augmented reality applications. For example, in one embodiment, the system can use LockAR data to create 3D vector shapes of objects (e.g., light paintings) in augmented reality. Based on the accurate environmental data, position and geometry information in a real-world location, the system can use an AR light painting technique to draw the vector shape using a simulation of lighting particles in the augmented reality scene for the on-site user devices and the off-site virtual augmented reality scene for the off-site user devices.

In some other embodiments, a user can wave a mobile phone as if it were aerosol paint can and the system can record the trajectory of the wave motion in the augmented reality scene. As FIG. 3C illustrates, the system can find accurate trajectory of the mobile phone based on the static LockAR data or to mobile LockAR by a mobile position orientation point, (MPOP).

The system can make animation that follows the wave motion in the augmented reality scene. Alternatively, the wave motion lays down a path for some AR object to follow in the augmented reality scene. Industrial users can use LockAR location vector definitions for surveying, architecture, ballistics, sports predictions, AR visualization analysis, and other physics simulations or for creating spatial ‘events’ that are data driven and specific to a location. Such events can be repeated and shared at a later time.

In one embodiment, a mobile device can be tracked, walked, or moved as a template drawing across any surface, or air . . . and vector generated AR content can then appear on that spot via digital device, as well as appear in a remote off site location. In another embodiment, vector created ‘air drawings’ can power animations and time/space related motion events of any scale or speed, again to be predictably shared off and on site, as well as edited and changed on either off and or on site, to be available as a system wide change to other viewers.

Similarly, as FIG. 3D illustrates; inputs from an off-site device can also be transferred to the augmented reality scene facilitated by an on-site device in real time. The system uses the same technique as in FIG. 3C to accurately line up to a position in GPS space with proper adjustments and offsets to improve accuracy of the GPS coordinates.

Off-Site Virtual Augmented Reality (“ovAR”)

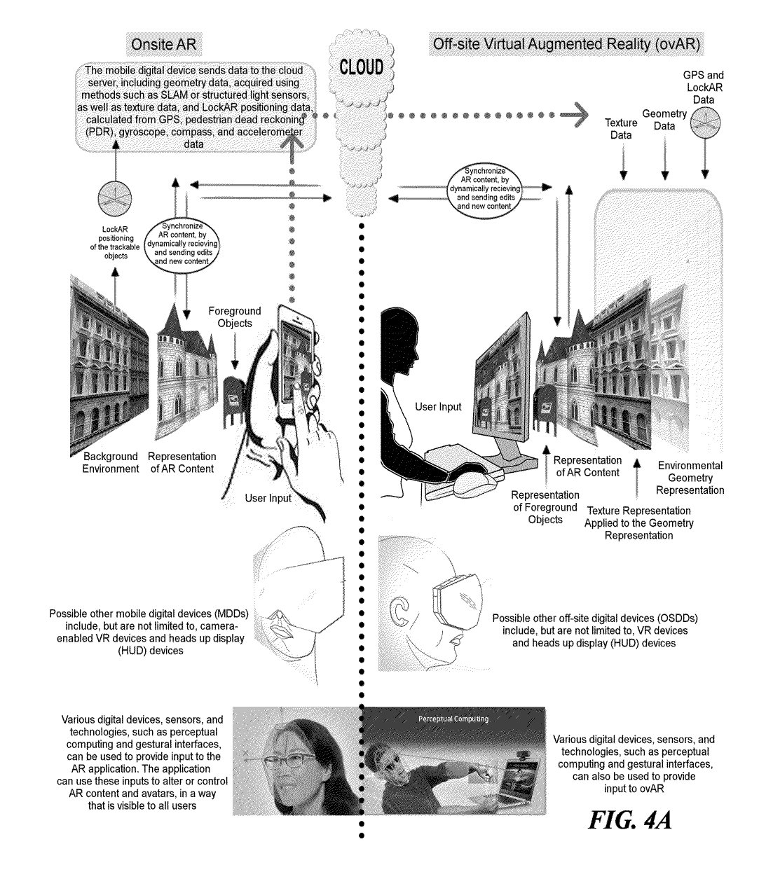

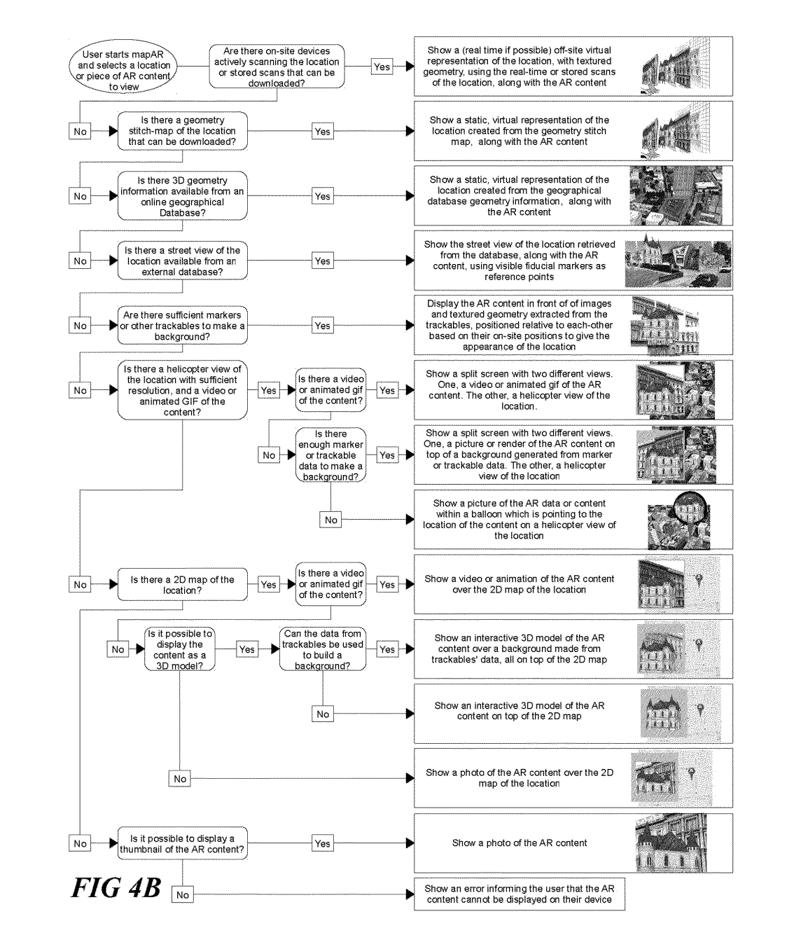

FIG. 4A is a flow diagram showing a mechanism for creating a virtual representation of on-site augmented reality for an off-site device (ovAR). As FIG. 4A illustrates, the on-site device sends data, which could include the positions, geometry, and bitmap image data of the background objects of the real-world scene, to the off-site device. The on-site device also sends positions, geometry, and bitmap image data of the other real-world objects it sees, including foreground objects to the off-site device. This information about the environment enables the off-site device to create a virtual representation (i.e., ovAR) of the real-world locations and scenes.

When the on-site device detects a user input to add a piece of augmented reality content to the scene, it sends a message to the server system, which distributes this message to the off-site devices. The on-site device further sends position, geometry, and bitmap image data of the AR content to the off-site devices. The illustrated off-site device updates its ovAR scene to include the new AR content. The off-site device dynamically determines the occlusions between the background environment, the foreground objects and the AR content, based on the relative positions and geometry of these elements in the virtual scene. The off-site device can further alter and change the AR content and synchronize the changes with the on-site device. Alternatively, the change to the augmented reality on the on-site device can be sent to the off-site device asynchronously. For example, when the on-site device cannot connect to a good Wi-Fi network or has poor cell phone signal reception, the on-site device can send the change data later when the on-site device has a better network connection.

The on-site and off-site devices can be, e.g., heads-up display devices or other AR/VR devices with the ability to convey the AR scene, as well as more traditional computing devices, such as desktop computers. In some embodiments, the devices can transmit user “perceptual computing” input (such as facial expression and gestures) to other devices, as well as use it as an input scheme (e.g. replacing or supplementing a mouse and keyboard), possibly controlling an avatar's expression or movements to mimic the user's. The other devices can display this avatar and the change in it's facial expression or gestures in response to the “perceptual computing” data.

The ovAR simulation on the off-site device does not have to be based on static predetermined geometry, textures, data, and GPS data of the location. The on-site device can share the information about the real-world location in real time. For example, the on-site device can scan the geometry and positions of the elements of the real-world location in real time, and transmit the changes in the textures or geometry to off-site devices in real time or asynchronously. Based on the real time data of the location, the off-site device can simulate a dynamic ovAR in real time. For example, if the real-world location includes moving people and objects, these dynamic changes at the location can also be incorporated as part of the ovAR simulation of the scene for the off-site user to experience and interact with including the ability to add (or edit) AR content such as sounds, animations, images, and other content created on the off-site device. These dynamic changes can affect the positions of objects and therefore the occlusion order when they are rendered. This allows AR content in both on-site and off-site applications to interact (visually and otherwise) with real-world objects in real time.

FIG. 4B is a flow diagram showing a process of deciding the level of geometry simulation for an off-site virtual augmented reality (ovAR) scene. The off-site device can determine the level of geometry simulation based on various factors. The factors can include, e.g., the data transmission bandwidth between the off-site device and the on-site device, the computing capacity of the off-site device, the available data regarding the real-world location and AR content, etc. Additional factors can include stored or dynamic environmental data, e.g., scanning and geometry creation abilities of on-site devices, availability of existing geometry data and image maps, off-site data and data creation capabilities, user uploads, as well as user inputs, and use of any mobile device or off-site systems.

As FIG. 4B illustrates, the off-site device looks for the highest fidelity choice possible by evaluating the feasibility of its options, starting with the highest fidelity and working its way down. While going through the hierarchy of locating methods, which to use will be partially determined by the availability of useful data about a location for each method, as well as whether a method is the best way to display the AR content on the user's device. For example, if the AR content is too small, the application will be less likely to use Google Earth, or if the AR marker can't be “seen” from street view, the system or application would use a different method. Whatever option it chooses, ovAR synchronizes AR content with other on-site and off-site devices so that if a piece of viewed AR content changes, the off-site ovAR application will change what it displays as well.

The off-site device first determines whether there are any on-site devices actively scanning the location, or if there are stored scans of the location that can be streamed, downloaded or accessed by the off-site device. If so, the off-site device creates a real-time virtual representation of the location, using data about the background environment and other data available about the location including the data about foreground objects, AR content, and displays it to the user. In this situation, any on-site geometry change can be synchronized in real time with the off-site device. The off-site device would detect and render occlusion and interaction of the AR content with the object and environmental geometry of the real-world location.

If there are not on-site devices actively scanning the location, the off-site device next determines whether there is a geometry stitch map of the location that can be downloaded. If so, the off-site device creates and displays a static virtual representation of the location using the geometry stitch map, along with the AR content. Otherwise, the off-site device continues evaluating, and determines whether there is any 3D geometry information for the location from any source such as an online geographical database (e.g., Google Earth). If so, the off-site device retrieves the 3D geometry from the geographical database and uses it to create the simulated AR scene, and then incorporates the proper AR content into it. For instance, point cloud information about a real world location could be determined by cross referencing satellite mapping imagery and data, street view imagery and data, and depth information from trusted sources. Using the point cloud created by this method, a user could position AR content, such as images, objects, or sounds, relative to the actual geometry of the location. This point cloud could, for instance, represent the rough geometry of a structure, such as a user's home. The AR application could then provide tools to allow users to accurately decorate the location with AR content. This decorated location could then be shared, allowing some or all on-site devices and off-site devices to view and interact with the decorations.

If at a specific location this method proves too unreliable to be used to place AR content or to create an ovAR scene, or if the geometry or point cloud information is not available, the off-site device continues, and determines whether a street view of the location is available from an external map database (e.g., Google Maps). If so, the off-site device displays a street view of the location retrieved from the map database, along with the AR content. If there is a recognizable fiducial marker available, the off-site device displays the AR content associated with the marker in the proper position in relation to the marker, as well as using the fiducial marker as a reference point to increase the accuracy of the positioning of the other displayed pieces of AR content.

If a street view of the location is not available or is unsuitable for displaying the content, then the off-site device determines whether there are sufficient markers or other Trackables around the AR content to make a background out of them, if so, the off-site device displays the AR content in front of images and textured geometry extracted from the Trackables, positioned relative to each-other based on their on-site positions to give the appearance of the location.

Otherwise, the off-site device determines whether there is a helicopter view of the location with sufficient resolution from an online geographical or map database (e.g., Google Earth or Google Maps), if so, the off-site device shows a split screen with two different views, in one area of the screen, a representation of the AR content, and in the other area of the screen, a helicopter view of the location. The representation of the AR content in one area of the screen can take the form of a video or animated gif of the AR content if there is such a video or animation is available; otherwise, the representation can use the data from a marker or another type of Trackable to create a background, and show a picture or render of the AR content on top of it. If there are no markers or other Trackables available, the off-site device can show a picture of the AR data or content within a balloon which is pointing to the location of the content, on top of the helicopter view of the location.

If there is not a helicopter view with sufficient resolution, the off-site device determines if there is a 2D map of the location and a video or animation (e.g., GIF animation) of the AR content, the off-site device shows the video or animation of the AR content over the 2D map of the location. If there is not a video or animation of the AR content, the off-site device determines whether it is possible to display the content as a 3D model on the device, and if so, whether it can use data from Trackables to build a background or environment. If so, it displays a 3D, interactive model of the AR content over a background made from the Trackable's data, on top of the 2D map of the location. If it is not possible to make a background from the Trackable's data, it simply displays a 3D model of the AR content over a 2D map of the location. Otherwise, if a 3D model of the AR content cannot be displayed on the user's device for any reason, the off-site device determines whether there is a thumbnail view of the AR content. If so, the off-site device shows the thumbnail of the AR content over the 2D map of the location. If there is not a 2D map of the location, the device simply displays a thumbnail of the AR content if possible. And if that is not possible, it displays an error informing the user that the AR content cannot be displayed on their device.

Even at the lowest level of ovAR representation, the user of the off-site device can change the content of the AR event. The change will be synchronized with other participating devices including the on-site device(s). It should be noted that “participating” in an AR event can be as simple as viewing the AR content in conjunction with a real world location or a simulation of a real world location, and that “participating” does not require that a user has or uses editing or interaction privileges.

The off-site device can make the decision regarding the level of geometry simulation for an off-site virtual augmented reality (ovAR) automatically (as detailed above) or based on a user's selection. For example, a user can choose to view a lower/simpler level of simulation of the ovAR if they wish.

### Platform for an Augmented Reality Ecosystem

The disclosed system can be a platform, a common structure, and a pipeline that allows multiple creative ideas and creative events to co-exist at once. As a common platform, the system can be part of a larger AR ecosystem. The system provides an API interface for any user to programmatically manage and control AR events and scenes within the ecosystem. In addition, the system provides a higher level interface to graphically manage and control AR events and scenes. The multiple different AR events can run simultaneously on a single users device, and multiple different programs can access and use the ecosystem at once.

### Exemplary Digital Data Processing Apparatus

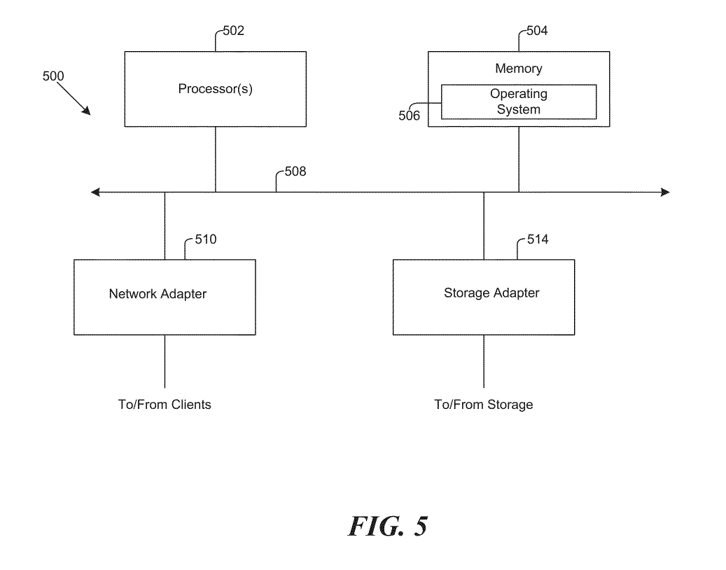

FIG. 5 is a high-level block diagram illustrating an example of hardware architecture of a computing device 500 that performs attribute classification or recognition, in various embodiments. The computing device 500 executes some or all of the processor executable process steps that are described below in detail. In various embodiments, the computing device 500 includes a processor subsystem that includes one or more processors 502. Processor 502 may be or may include, one or more programmable general-purpose or special-purpose microprocessors, digital signal processors (DSPs), programmable controllers, application specific integrated circuits (ASICs), programmable logic devices (PLDs), or the like, or a combination of such hardware based devices.

The computing device 500 can further include a memory 504, a network adapter 510 and a storage adapter 514, all interconnected by an interconnect 508. Interconnect 508 may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other data communication system.

The computing device 500 can be embodied as a single- or multi-processor storage system executing a storage operating system 506 that can implement a high-level module, e.g., a storage manager, to logically organize the information as a hierarchical structure of named directories, files and special types of files called virtual disks (hereinafter generally “blocks”) at the storage devices. The computing device 500 can further include graphical processing unit(s) for graphical processing tasks or processing non-graphical tasks in parallel.

The memory 504 can comprise storage locations that are addressable by the processor(s) 502 and adapters 510 and 514 for storing processor executable code and data structures. The processor 502 and adapters 510 and 514 may, in turn, comprise processing elements and/or logic circuitry configured to execute the software code and manipulate the data structures. The operating system 506, portions of which is typically resident in memory and executed by the processors(s) 502, functionally organizes the computing device 500 by (among other things) configuring the processor(s) 502 to invoke. It will be apparent to those skilled in the art that other processing and memory implementations, including various computer readable storage media, may be used for storing and executing program instructions pertaining to the technology.

The memory 504 can store instructions, e.g., for a body feature module configured to locate multiple part patches from the digital image based on the body feature databases; an artificial neural network module configured to feed the part patches into the deep learning networks to generate multiple sets of feature data; a classification module configured to concatenate the sets of feature data and feed them into the classification engine to determine whether the digital image has the image attribute; and a whole body module configured to processing the whole body portion.

The network adapter 510 can include multiple ports to couple the computing device 500 to one or more clients over point-to-point links, wide area networks, virtual private networks implemented over a public network (e.g., the Internet) or a shared local area network. The network adapter 510 thus can include the mechanical, electrical and signaling circuitry needed to connect the computing device 500 to the network. Illustratively, the network can be embodied as an Ethernet network or a WiFi network. A client can communicate with the computing device over the network by exchanging discrete frames or packets of data according to predefined protocols, e.g., TCP/IP.

The storage adapter 514 can cooperate with the storage operating system 506 to access information requested by a client. The information may be stored on any type of attached array of writable storage media, e.g., magnetic disk or tape, optical disk (e.g., CD-ROM or DVD), flash memory, solid-state disk (SSD), electronic random access memory (RAM), micro-electro mechanical and/or any other similar media adapted to store information, including data and parity information.

### AR Vector

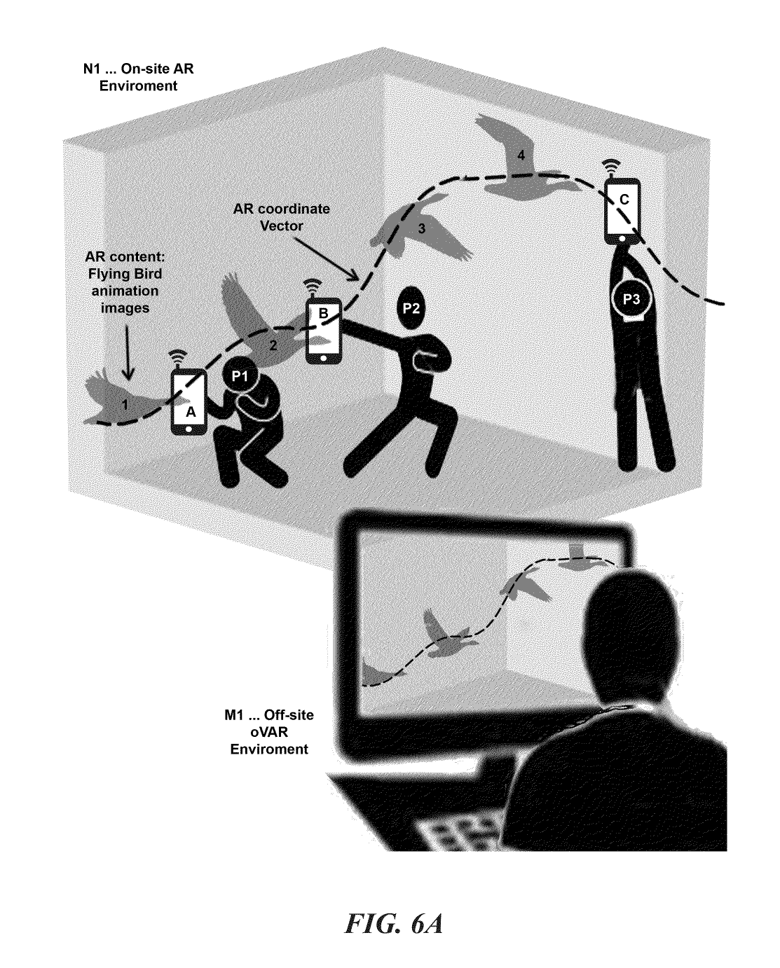

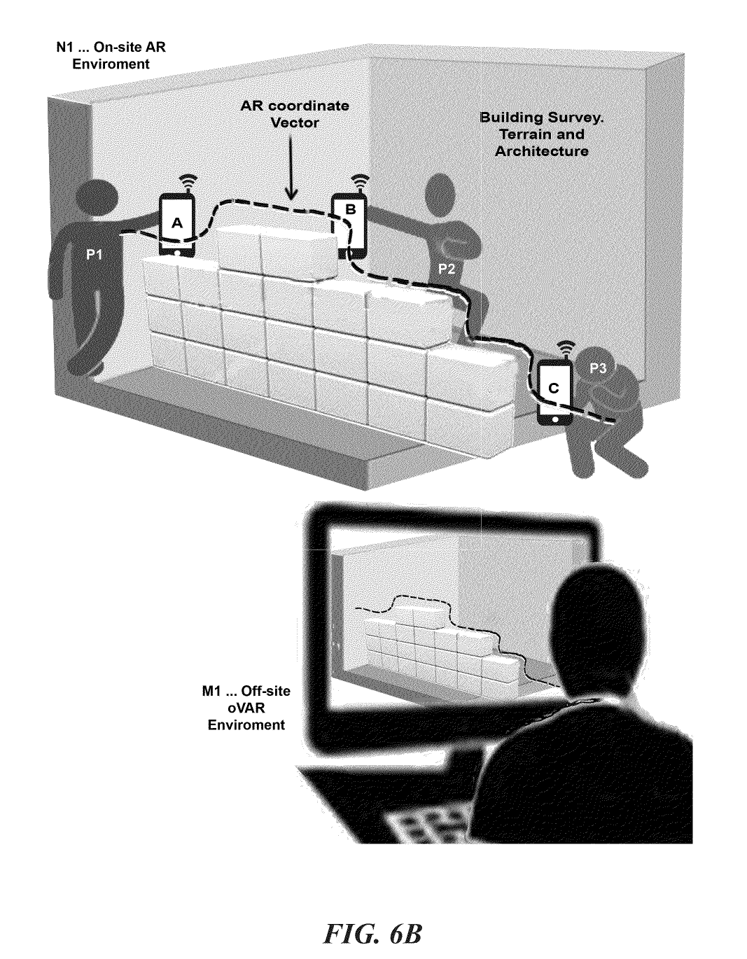

FIG. 6A is an illustrative diagram showing an AR Vector being viewed both on-site and off-site simultaneously. FIG. 6A depicts a user moving from position 1 (P1) to position 2 (P2) to position 3 (P3), while holding a MDD enabled with sensors, such as compasses, accelerometers, and gyroscopes, that have motion detection capabilities. This movement is recorded as a 3D AR Vector. This AR Vector is initially placed at the location where it was created. In FIG. 6A, the AR bird in flight follows the path of the Vector created by the MDD.

Both off-site and on-site users can see the event or animation live or replayed at a later time. Users then can collaboratively edit the AR Vector together all at once or separately over time.

An AR Vector can be represented to both on-site and off-site users in a variety of ways, for example, as a dotted line, or as multiple snapshots of an animation. This representation can provide additional information through the use of color shading and other data visualization techniques.

An AR Vector can also be created by an off-site user. On-site and off-site users will still be able to see the path or AR manifestation of the AR Vector, as well as collaboratively alter and edit that Vector.

FIG. 6B is another illustrative diagram showing in N1 an AR Vector's creation, and in N2 the AR Vector and its data being displayed to an off-site user. FIG. 6B depicts a user moving from position 1 (P1) to position 2 (P2) to position 3 (P3), while holding a MDD enabled with sensors, such as compasses, accelerometers, and gyroscopes, that have motion detection capabilities. The user treats the MDD as a stylus, tracing the edge of existing terrain or objects. This action is recorded as a 3D AR Vector placed at the specific location in space where it was created. In the example shown in FIG. 6B, the AR Vector describes the path of the building's contour, wall, or surface. This path may have a value (which can take the form of an AR Vector) describing the distance offsetting the AR Vector recorded from the AR Vector created. The created AR Vector can be used to define an edge, surface, or other contour of an AR object. This could have many applications, for example, the creation of architectural previews and visualizations.

Both off-site and on-site users can view the defined edge or surface live or at a later point in time. Users then can collaboratively edit the defining AR Vector together all at once or separately over time.

Off-site users can also define the edges or surfaces of AR objects using AR Vectors they have created. On-site and off-site users will still be able to see the AR visualizations of these AR Vectors or the AR objects defined by them, as well as collaboratively alter and edit those AR Vectors.

In order to create an AR Vector, the on-site user generates positional data by moving an on-site device. This positional data includes information about the relative time each point was captured at, which allows for the calculation of velocity, acceleration, and jerk data. All of this data is useful for a wide variety of AR applications including but not limited to: AR animation, AR ballistics visualization, AR motion path generation, and tracking objects for AR replay. The act of AR Vector creation may employ IMU by using common techniques such as accelerometer integration. More advanced techniques can employ AR Trackables to provide higher quality position and orientation data. Data from Trackables may not be available during the entire AR Vector creation process; if AR Trackable data is unavailable, IMU techniques can provide positional data.

Beyond simply the IMU, almost any input, (for example, RF trackers, pointers, laser scanners, etc.) can be used to create on-site AR Vectors. The AR Vectors can be accessed by multiple digital and mobile devices, both on-site and off-site, including ovAR. Users then can collaboratively edit the AR Vectors together all at once or separately over time.

Both on-site and off-site digital devices can create and edit AR Vectors. These AR Vectors are uploaded and stored externally in order to be available to on-site and off-site users. These changes can be viewed by users live or at a later time.

The relative time values of the positional data can be manipulated in a variety of ways in order to achieve effects, such as alternate speeds and scaling. Many sources of input can be used to manipulate this data, including but not limited to: midi boards, styli, electric guitar output, motion capture, and pedestrian dead reckoning enabled devices. The AR Vector's positional data can also be manipulated in a variety of ways in order to achieve effects. For example, the AR Vector can be created 20 feet long, then scaled by a factor of 10 to appear 200 feet long.

Multiple AR Vectors can be combined in novel ways. For instance, if AR Vector A defines a brush stroke in 3d space, AR Vector B can be used to define the coloration of the brush stroke, and AR Vector C can then define the opacity of the brush stroke along AR Vector A.

AR Vectors can be distinct elements of content as well; they are not necessarily tied to a single location or piece of AR content. They may be copied, edited, and/or moved to different coordinates.

The AR Vectors can be used for different kinds of AR applications such as: surveying, animation, light painting, architecture, ballistics, sports, game events, etc. There are military uses of AR Vectors; such as coordination of human teams with multiple objects moving over terrain, etc.

### Other Embodiments

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the present invention contemplates various changes beyond such specific order.

1. A computer-implemented method for providing a shared augmented reality experience, the method comprising:
receiving, at an on-site device in proximity to a real-world location, a location coordinate of the on-site device;
sending, from the on-site device to a server, a request for available AR content and for position and geometry data of objects of the real-world location based on the location coordinate;
receiving, at the on-site device, AR content as well as environmental data including position and geometry data of objects of the real-world location;
visualizing, at the on-site device, an augmented reality representation of the real-world location by presenting augmented reality content incorporated into a live view of the real-world location;
forwarding, from the on-site device to an off-site device remote to the real-world location, the AR content as well as the position and geometry data of objects in the real-world location to enable the off-site device to visualize a virtual representation of the real-world by creating virtual copies of the objects of the real-world location, wherein the off-site device incorporates the AR content in the virtual representation; and
synchronizing a change to the augmented reality representation on the on-site device with the virtual augmented reality representation on the off-site device.

2. The method of claim 1, further comprising:
synchronizing a change to the virtual augmented reality representation on the off-site device with the augmented reality representation on the on-site device.

3. The method of claim 1, wherein the change to the augmented reality representation on the on-site device is sent to the off-site device asynchronously.

4. The method of claim 1, wherein the synchronizing comprises:
receiving, from an input component of the on-site device, a user instruction to create, alter, move or remove augmented reality content in the augmented reality representation;
updating, at the on-site device, the augmented reality representation based on the user instruction; and
forwarding, from the on-site device to the off-site device, the user instruction such that the off-site device can update its virtual representation of the augmented reality scene according to the user instruction.

5. The method of claim 1, further comprising:
receiving, at the on-site device from the off-site device, a user instruction for the off-site device to create, alter, move or remove augmented reality content in its virtual augmented reality representation; and
updating, at the on-site device, the augmented reality representation based on the user instruction such that the status of the augmented reality content is synchronized between the augmented reality representation and the virtual augmented reality representation.

6. The method of claim 1, further comprising:
capturing environmental data including but not limited to live video of the real-world location, live geometry and exiting texture information, by the on-site device.

7. The method of claim 1, further comprising:
sending, from the on-site device to the off-site device, the textural image data of the objects of the real-world location.

8. The method of claim 1, wherein the synchronizing comprises:
synchronizing a change to the augmented reality representation on the on-site device with multiple virtual augmented reality representations on multiple off-site devices and multiple augmented reality representations on other on-site devices.

9. The method of claim 1, wherein the augmented reality content comprises a video, an image, a piece of artwork, an animation, text, a game, a program, a sound, a scan or a 3D object.

10. The method of claim 9, wherein the augmented reality content contains a hierarchy of objects including but not limited to shaders, particles, lights, voxels, avatars, scripts, programs, procedural objects, images, or visual effects, or wherein the augmented reality content is a subset of an object.

11. The method of claim 1, further comprising:
establishing, by the on-site device, a hot-editing augmented reality event by automatically or manually sending invitations or allowing public access to multiple on-site or off-site devices.

12. The method of claim 1, wherein the on-site device maintains its point of view of the augmented reality at the location of the on-site device at the scene.

13. The method of claim 12, wherein the virtual augmented reality representation of the off-site device follows the point of view of the on-site device.

14. The method of claim 1, wherein the off-site device maintains its point of view of the virtual augmented reality representation as a first person view from the avatar of the user of the off-site device in the virtual augmented reality representation, or as a third person view of the avatar of the user of the off-site device in the virtual augmented reality representation.

15. The method of claim 1, further comprising:
capturing, at the on-site or off-site device, a facial expression or a body gesture of a user of said device;
updating, at said device, a facial expression or a body positioning of the avatar of the user of the device in the augmented reality representation; and
sending, from the device to all other devices, information of the facial expression or the body gesture of the user to enable the other devices to update the facial expression or the body positioning of the avatar of the user of said device in the virtual augmented reality representation.

16. The method of claim 1, wherein communications between the on-site device and the off-site device are transferred through a central server, a cloud server, a mesh network of device nodes, or a peer-to-peer network of device nodes.

17. The method of claim 1, further comprising:
forwarding, by the on-site device to another on-site device, the AR content as well as the environmental data including the position and the geometry data of the objects of the real-world location, to enable the other on-site device to visualize the AR content in another location similar to the real-world location proximate to the on-site device; and
synchronizing a change to the augmented reality representation on the on-site device with another augmented reality representation on the other on-site device.

18. The method of claim 1, wherein the change to the augmented reality representation on the on-site device is stored on an external device and persists from session to session.

19. The method of claim 18, wherein the change to the augmented reality representation on the on-site device persists for a predetermined amount of time before being erased from the external device.

20. The method of claim 19, wherein communications between the on-site device and the other on-site device are transferred though an ad hoc network.

21. The method of claim 20, wherein the change to the augmented reality representation does not persist from session to session, or from event to event.

22. The method of claim 1, further comprising:
extracting data needed to track real-world object(s) or feature(s), including but not limited to geometry data, point cloud data, and textural image data, from public or private sources of real world textural, depth, or geometry information, e.g. Google Street View, Google Earth, and Nokia Here; using techniques such as photogrammetry and SLAM.

23. A system for providing a shared augmented reality experience, the system comprising:
one or more on-site devices for generating augmented reality representations of a real-world location; and
one or more off-site devices for generating virtual augmented reality representations of the real-world location;
wherein the augmented reality representations include content visualized and incorporated with live views of the real-world location;
wherein the virtual augmented reality representations include the content visualized and incorporated with live views in a virtual augmented reality world representing the real-world location; and
wherein the on-site devices synchronize the data of the augmented reality representations with the off-site devices such that the augmented reality representations and the virtual augmented reality representations are consistent with each other.

24. The method of claim 23, wherein there are zero off-site devices, and the on-site devices communicate through either a peer-to-peer network, a mesh network, or an ad hoc network.

25. The system of claim 23, wherein an on-site device is configured to identify a user instruction to change data or content of the on-site device's internal representation of AR; and
wherein the on-site device is further configured to send the user instruction to other on-site devices and off-site devices of the system so that the augmented reality representations and the virtual augmented reality representations within the system reflect the change to the data or content consistently in real time.

26. The system of claim 23, wherein an off-site device is configured to identify a user instruction to change the data or content in the virtual augmented reality representation of the off-site device; and
wherein the off-site device is further configured to send the user instruction to other on-site devices and off-site devices of the system so that the augmented reality representations and the virtual augmented reality representations within the system reflect the change to the data or content consistently in real time.

27. The system of claim 23, further comprising:
a server for relaying and/or storing communications between the on-site devices and the off-site devices, as well as the communications between on-site devices, and the communications between off-site devices.

28. The system of claim 23, wherein the users of the on-site and off-site devices participate a shared augmented reality event.

29. The system of claim 23, wherein the users of the on-site and off-site devices are represented by avatars of the users visualized in the augmented reality representations and virtual augmented reality representations; and wherein augmented reality representations and virtual augmented reality representations visualize that the avatars participate in a shared augmented reality event in a virtual location or scene as well as a corresponding real-world location.

30. A computer device for sharing augmented reality experiences, the computer device comprising of:
a network interface configured to receive environmental, position, and geometry data of a real-world location from an on-site device in proximity to the real-world location;
the network interface further configured to receive augmented reality data or content from the on-site device;
an off-site virtual augmented reality engine configured to create a virtual representation of the real-world location based on the environmental data including position and geometry data received from the on-site device; and
an engine configured to reproduce the augmented reality content in the virtual representation of reality such that the virtual representation of reality is consistent with the augmented reality representation of the real-world location (AR scene) created by the on-site device.

31. The system of claim 30, wherein the computer device is remote to the real-world location.

32. The system of claim 30, wherein the network interface is further configured to receive a message indicating that the on-site device has altered the augmented reality overlay object in the augmented reality representation or scene; and
wherein the data and content engine is further configured to alter the augmented reality content in the virtual augmented reality representation based on the message.

33. The system of claim 30, further comprising:
An input interface configured to receive a user instruction to alter the augmented reality content in the virtual augmented reality representation or scene;
wherein the overlay engine is further configured to alter the augmented reality content in the virtual augmented reality representation based on the user instruction; and
wherein the network interface is further configured to send an instruction from a first device to a second device to alter an augmented reality overlay object in an augmented reality representation of the second device.

34. The system of claim 30, wherein
the instruction was sent from the first device which is an on-site device to the second device which is an off-site device; or
the instruction was sent from the first device which is an off-site device to the second device which is an on-site device; or
the instruction was sent from the first device which is an on-site device to the second device which is an on-site device; or
the instruction was sent from the first device which is an off-site device to the second device which is an off-site device.

35. The system of claim 30, wherein the position and geometry data of the real-world location include data collected using any or all of the following: fiducial marker technology, simultaneous localization and mapping (SLAM) technology, global positioning system (GPS) technology, dead reckoning technology, beacon triangulation, predictive geometry tracking, image recognition and or stabilization technologies, photogrammetry and mapping technologies, and any conceivable locating or specific positioning technology.

36. A method for sharing augmented reality positional data and the relative time values of that positional data, the method comprising:
receiving, from at least one on-site device, positional data and the relative time values of that positional data, collected from the motion of the on-site device;
creating an augmented reality (AR) three-dimensional Vector based on the positional data and the relative time values of that positional data;
placing the augmented reality Vector at a location where the positional data was collected; and
visualizing a representation of the augmented reality Vector with a device.

37. The method of claim 36, wherein the representation of the augmented reality Vector includes additional information through the use of color shading and other data visualization techniques.

38. The method of claim 36, wherein the AR Vector defines the edge or surface of a piece of AR content, or otherwise acts as a parameter for that piece of AR content.

39. The method of claim 36, wherein the included information about the relative time that each point of positional data was captured at, on the on-site device allows for the calculation of velocity, acceleration and jerk data.

40. The method of claim 39, further comprising:
Creating from the positional data and the relative time values of that positional data, objects and values including but not limited to an AR animation, an AR ballistics visualization, or a path of movement for an AR object.

41. The method of claim 36, wherein the device's motion data that is collected to create the AR Vector is generated from sources including, but not limited to, the internal motion units of the on-site device.

42. The method of claim 36, wherein the AR Vector is created from input data not related to the device's motion, generated from sources including but not limited to RF trackers, pointers, or laser scanners.

43. The method of claim 36, wherein the AR Vector is accessible by multiple digital and mobile devices, wherein the digital and mobile device can be on-site or off-site, wherein the AR Vector is viewed in real time or asynchronously.

44. The method of claim 36, wherein one or more on-site digital devices or one or more off-site digital devices can create and edit the AR Vector. Creations and edits to the AR Vector can be seen by multiple on-site and off-site users live, or at a later time. Creation and editing, as well as viewing creation and editing, can either be done by multiple users simultaneously, or over a period of time.

45. The method of claim 36, wherein the data of the AR Vector is manipulated in a variety of ways in order to achieve a variety of effects, including, but not limited to: changing the speed, color, shape, and scaling.

45. The method of claim 35, wherein various types of input can be used to create or change the AR Vector's positional data vector, including, but not limited to: midi boards, styli, electric guitar output, motion capture, and pedestrian dead reckoning enabled devices.

47. The method of claim 36, wherein the AR Vector positional data can be altered so that the relationship between the altered and unaltered data is linear.

48. The method of claim 36, wherein the AR Vector positional data can be altered so that the relationship between the altered and unaltered data is nonlinear.

49. The method of claim 36, further comprising:
A piece of AR content which uses multiple augmented reality Vectors as parameters.

50. The method of claim 36, wherein the AR Vector can be a distinct element of content, independent of a specific location or piece of AR content. They can be copied, edited and/or moved to different positional coordinates.

51. The method of claim 36, further comprising:
using the AR Vector to create content for different kinds of AR applications, including but not limited to: surveying, animation, light painting, architecture, ballistics, training, gaming, and national defense.
